(19) United States
(12) Patent Application Publication
(10) Pub. No.: US 2024/0111974 A1
(43) Pub. Date: Apr. 4, 2024

(54) System for RFID Edge Zone Identification and Data Capture

(71) Applicant: Trilliott, Inc., Raleigh, NC (US)

(72) Inventor: James Booth Kalmbach, JR., Raleigh, NC (US)

(21) Appl. No.: 18/477,913

(22) Filed: Sep. 29, 2023

Related U.S. Application Data
(60) Provisional application No. 63/411,262, filed on Sep. 29, 2022.

(51) Int. Cl. G06K 7/10

(52) U.S. Cl. CPC G06K 7/10366

(57) ABSTRACT

RFID Edge Capture eliminates the problem of over-scanning RFID tags from a phased-array RFID scanner by defining and calibrating a Capture Zone, defining an Ingress Line, and compiling Movement Events of collections of Item tags transiting the Capture Zone as aggregated by a Thresholding Algorithm. The Capture Zone may be defined by placing three or more specially designated Calibrator tags at vertices of the Capture Zone and then determining the locations of the Calibrators during a Calibration Mode. The Ingress line may be determined as a straight line between two designated Calibrators. Movement Events may be stored in a database for persistence and may be typed as ingress or egress based upon the direction of movement. Loiterers (stationary tags near a capture zone) and Drive-bys (tags that move past the Capture Zone but do not ingress or egress) may be eliminated from the data.

### CROSS-REFERENCE TO RELATED APPLICATION

This application claims priority to of U.S. Provisional Patent Application No. 63/411,262, filed Sep. 29, 2022 and entitled “System for RFID Edge Zone Identification and Data Capture”.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

This document describes the concepts and algorithms underlying the Trilliott Edge Capture functions of Trilliott SmartSITE, in support of U.S. patent applications, and for Trilliott SmartSITE registered trademark filings.

Trilliott SmartSITE, a commercial product offering of Trilliott, Inc., is software-as-a-service for digitizing and managing enterprise inventory and assets. Trilliott SmartSITE vastly improves accuracy and efficiency in supply chain and warehouse activities by focusing on the trillions of assets used in everyday operations, and by leveraging RAIN RFID technology.

RAIN RFID (www.rainrfid.org/about-rain/what-is-rain) is a wireless technology that connects tens of billions of everyday items to the internet, enabling businesses to identify, locate, authenticate, and engage each item. RAIN RFID uses the GS1 UHF Gen2 protocol (www.gs1.org/standards/rfid), which ISO/IEC has standardized as 18000-63. The typical RAIN RFID solution uses standardized scanners to read and write standardized sensors (RFID tags), which are battery-less, inexpensive labels, with a range up to 60 feet.

The ISO/IEC standards and RAIN RFID use cases define how a RAIN RFID tag is formatted and how a RAIN RFID scanner communicates to the tag. The ISO/IEC standards do not describe how the standard is used to deliver value.

### BRIEF DESCRIPTION OF THE DRAWINGS

Certain illustrative embodiments illustrating organization and method of operation, together with objects and advantages may be best understood by reference to the detailed description that follows taken in conjunction with the accompanying drawings in which:

FIG. 1 is an isometric view of a capture zone consistent with certain embodiments of the present invention.

FIG. 2 is a screen view of an exemplar dashboard display consistent with certain embodiments of the present invention.

FIG. 3 is an architectural view of the tier-node model utilized to execute application code consistent with certain embodiments of the present invention.

FIG. 4 is a screen view of the functional hierarchy for execution of applications in the platform consistent with certain embodiments of the present invention.

FIG. 5 is an architectural view of the application code layers for access by developers consistent with certain embodiments of the present invention.

FIG. 6 is a description of how data elements are represented in the application platform consistent with certain embodiments of the present invention.

FIG. 7 is an operational view of the use of controls in the platform consistent with certain embodiments of the present invention.

FIG. 8 is an operational example of a device in use with the platform consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

### Definitions

Application—an entire customer solution, including all user interfaces, database, and reporting functions. In a non-limiting example, SmartSITE Capture, an application operative within the Trilliott Platform, is an application.
User Task—a component that executes work flow to control a user interface, such as an interface that is optimized for user interaction.
Daemon Task—a task that runs in the background to provide a specific service which is optimized for throughput.
Container—a software component that executes Tasks and connects Resources.
Resource—a service used by a Task to capture, present, or communicate data with a process or physical device or virtual device.
Node—the location where a Bench process executes.
Tier—a categorization of Nodes, such as, in non-limiting examples, cloud as a networked server farm, edge as a premise such as home or workplace, and device as a dedicated processor such as a sensor.
Database of Things—the schema and metadata and data that describe each application. There is a common schema and metadata, but usually differences in data between different applications and Tenants.
Tenant—one customer's view of the Database of Things.
Shard—a contextual portion of a Tenant's view.
Replication—The process of keeping a shard in sync with a Tenant's Database of Things view.
Console—the process that presents the user interface on a display device.
Form—a visible section of Task logic, for example, a page.
Control—a unit of interaction on a Form, for example, a button or dropdown.
Grouping Interval—a time interval defined by the passage through a capture zone of multiple sensors or tags that are associated with things. The Grouping Interval time interval is initiated when a first sensor or tag is detected within a capture zone and is closed when a previously undetected sensor or tag has not entered said capture zone after a pre-defined time span has lapsed. Typically a grouping interval will capture and assign sensor or tag detections captured within a two — five second time period to the same Grouping Interval, placing each sensor or tag information packet captured within that time period to the same Group of things.
RAIN—an acronym derived from Radio frequency IdentificatioN is a link between UHF RFID and the cloud, where RFID-based data may be stored, managed and shared via a networked connection.

### Trilliott Platform Architecture

The Trilliott Platform is the software system supporting all features and functions Trilliott makes available to its customers.

The Trilliott Platform is architected to be hybrid-peer-to-peer: any execution unit, or instance, may run on the edge or in the cloud, on a variety of operating systems, independently and concurrently without any predisposition to hierarchy, and can communicate with other instances regardless of locality.

The operation of each instance is configured from the Trilliott Database of Things, which is sharded according to the data that instance requires.

The Trilliott Platform is inherently an Internet of Things platform designed to interface with sensors and manage sensor-based workflows.

The Trilliott Platform contains a Trilliott Bench function. The Trilliott Bench is a software IoT framework operative on a cloud+edge networked environment within a premise. The Trilliott Bench also includes a set of Application Program Interfaces (APIs) that provides services for creating and managing a container, provisioning, creating and managing a Database of Things, and third-Party Integration with the Trilliott Platform.

The Trilliott Bench is based upon the Container concept. Containers provide an operational environment to permit programmers to define workflows and resources that travel with applications as they operate in the cloud, on handsets, tablets, portable computers, smart phones, and desktop computers. Programmers may create an application on a laptop, test it in the laptop environment, and when testing is complete the programmer may publish the application. The application will provide the same functionality on every computerized platform in which the Trilliott Bench may be installed.

### The Application Layer

The Trilliott Platform performs workflow. Each unit of workflow is an App running in the Application Layer. An App is a set of Tasks that run wherever needed, on the edge or in the networked cloud. Apps may express a user interface, like a browser dashboard or a mobile touchscreen. Apps may also run as daemons with no user interface. A Task manages resources via forms, devices, and Daemons connected by Transports. In non-limiting examples, a Form many manages the User Interface (UI) on a console page, a Device may manage physical devices and sensors, and a Daemon may be a background controller.

The Application Layer uses a Container design pattern such that all Apps are coded through a common Trilliott API and can run on any supported operating system in any location, cloud or edge.

In the Application Layer communication between elements is performed through Web Sockets that provide for full-duplex, peer-to-peer implementation. In this model the application may initiate communication between a task and a device, for example, and either side may then perform full communications such as requests, queries, and other operational messages or control requests.

In an embodiment, the Trilliott Platform utilizes JSON Representational State Transfer (JSON-REST) to transition from state to state. A transaction is a Request plus Response and is independent of all other transactions. An action is invoked on a resource, which manages records. The JSON-REST methods implemented in the Trilliott Application Layer include Post, to allocate a resource and invoke an action to create or manipulate records, Put, to add records to a resource via a registered Put handler, and Delete, to delete records as required and deallocate a resource as required.

In an embodiment, a resource has a Controller Factory that manages Controllers. A Controller interfaces with a Device to create Records, manipulates Records via Tasks, puts Records via a Transport and may have Controls. A Control interfaces with a device and creates Records.

The special capabilities of the Trilliott Platform simplify building Solutions that digitize, deploy, control, and analyze assets, and manage lifecycle at enterprise scale for very large volumes of inventory and assets.

A Solution is comprised of a set of Apps operating for a common purpose, like SmartSITE Supply Chain Management, SmartSITE Warehouse Management, and SmartSITE Asset Management.

### The Execution Layer

Apps operate on digital assets, the properties, behaviors, and interactions of which are digitized by the Execution Layer as Events. The Execution Layer may be configured to inject Events into The Application Layer, and also to legacy systems, such as Enterprise Resource Planning, Manufacturing Resource Planning, Warehouse Management Systems, and so forth.

The Execution Layer comprises the following.
Transaction System. The Transaction System ingests Events from Edge Capture, persists them in its local database, and transacts with the Application Layer or with external legacy systems, to forward Events according to configuration.
Edge Capture. Edge Capture is the focus of this document. It collects the raw sensor input from the Hardware Interface, then aggregates, groups, filters, and processes it to formulate business events.
Hardware Interface. The Hardware Interface controls hardware, principally hardware like RAIN RFID scanners and tags, in a hardware-agnostic manner such that hardware from different vendors is interchangeable without impacting applications, thereby future-proofing Trilliott applications.

### Edge Capture Intellectual Property

Like barcode sensing, RFID sensing is an identification technology. But in contrast to barcode sensing, which identifies one thing at a time, RFID sensing inherently identifies sets of simultaneous things. When you pull the trigger on an RFID scanner, you may find thousands of things at once—pallets, people, places, pants, and discarded hamburger wrappers.

Edge Capture is tasked with consuming the voluminous inflow of things and extracting discreet Events like movements, counts, groupings, triggers, and also singulations—a single desired identity from the cacophony.

The Edge Capture system has invented, perfected and proved its extraction algorithms, the sophistication of which is facilitated by the compute power now available on the edge. For example, to validate an asset, a modern mobile tablet can query an edge database shard of hundreds of thousands of things occupying no more storage than a video, and get the response in milliseconds.

### The Problem

Manual scanning, even with handheld RFID scanning such as a Trilliott SmartSITE handset app, is labor intensive and expensive. Consequently, manual scans are often incomplete, or are skipped altogether, resulting in a loss of inventory accuracy.

RFID scanning can be automated with fixed RFID antennas positioned on the sides of a doorway. Each antenna emits an RFID beam, so multiple antennas are deployed to increase capture rates. At $40K or more per door, fixed RFID is expensive to install, impeding its adoption.

Furthermore, to improve the penetration of the single emitted beam, transmission power is set at maximum. While high power increases the number of tags identified, it creates another big problem: Over Scanning.

Over Scanning causes erroneous identification of Loiterers — tags on stationary material left nearby, and Drive-Bys—tags on material moving past the door and not through it.

These problems impede RAIN RFID adoption.

### Phased-Array RFID Scanner Technology

Phased-array RFID scanners, commercially available for some time now, are extraordinary powerful. Emitting one hundred steered RF beams from a single 18-inch-square scanner, versus a single beam per antenna from a fixed scanner, an RFID phased scanner can identify over 1,500 tags per second, and generate an x-y coordinate for each tag identification.

Furthermore, phased-array RFID scanners can be mounted from the ceiling out of the way of traffic, greatly simplifying installation. Fewer phased-array RFID scanners cover larger areas. Overall, phased-array RFID scanners are more practical than fixed RFID scanners and less expensive to deploy.

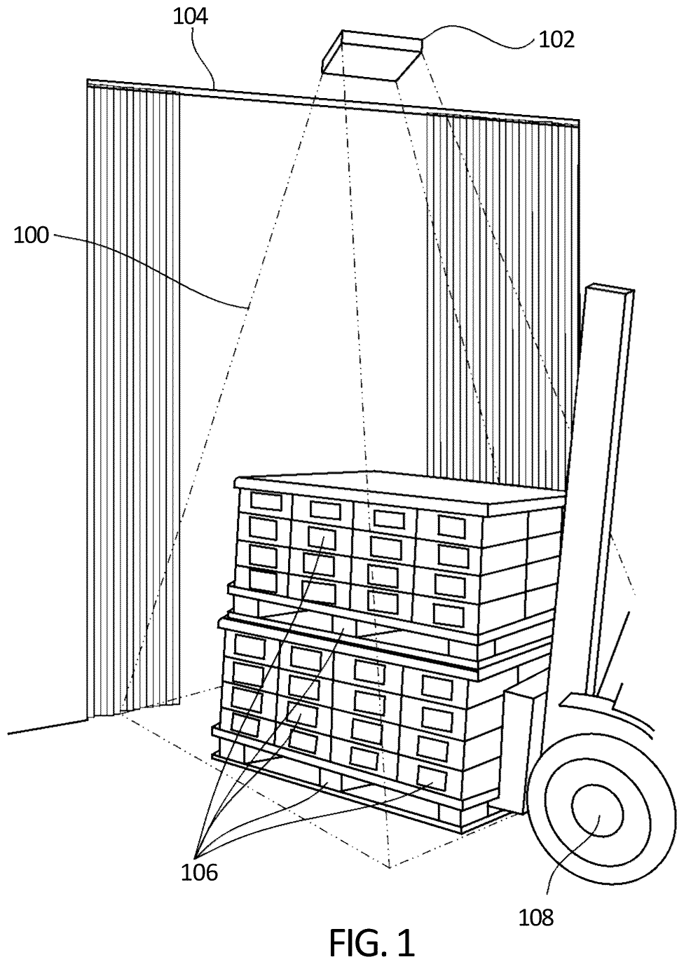

FIG. 1 shows a ceiling-mounted phased-array RFID scanner monitoring an inside door for the movement of industrial materials.

### The Invention: The Capture Zone

Despite their superior performance and convenience, phased-array RFID scanners suffer from the same over-scanning problem as fixed RFID scanners.

Kalmbach has solved the over-scanning problem leveraging the unique capabilities of phased-array RFID scanners to position tags, and creating a new software invention termed the Capture Zone. The Capture Zone defines a virtual convex polyhedron that sensors or tags that are affixed to or associated with things must move through.

Alternatively, the Capture Zone may be defined as a virtual convex polyhedron that is established by a scanner that is either held in the hand of a person moving through a facility, or mounted on a vehicle that is moving through a facility, where the Capture Zone is active to acquire and store all encoded strings from each sensor or tag from which a signal is acquired. The movement of the phased-array RFID scanner provides a moveable Capture Zone as the phased-array RFID scanner changes position throughout a facility. The id and location information encoded in the encoded strings may be associated with particular things to which each sensor or tag is assigned or affixed and may be stored and cross-referenced within a database schema that is stored within and maintained by the Edge Capture system.

### Capture Zone Calibration

The purpose of Calibration is twofold.
1. Automatically define the vertices of the polyhedron tags move through.
2. Inherently adjust for RF field variations caused by reflections and shadows.

### The Calibration Algorithm

1. Software, termed a Controller, commands phased-array RFID scanners to capture RFID tags, implements a Database of Things for information persistence, and generates a Dashboard, for example, a browser or app page that displays information including a cartesian graph.
2. Physical objects that the Controller tracks and manages longitudinally, for example, inventory and materials, are affixed with RFID tags encoded so as to be distinguished as Items, for example, as GRAI and SGTIN under the GS1 EPC Tag Data Standard, which defines GRAI as “Returnable Asset” and SGTIN as “Pallet or Trade Item”.
3. A location is commissioned as a Gate, an area through which Items will pass, and persisted in the Database of Things.
4. A phased-array RFID scanner is installed above the physical Gate area at a height that optimizes its coverage of the Gate, and commissioned as a Spatial Reader. It is associated with the Gate, and it, its height, transmission power, and other properties needed for its operation are persisted in the Database of Things.
5. During the commissioning of the Gate, four (three or more) RFID tags are encoded in such a way that the Controller can distinguish them from Items, for example, as SGLN (“Location”) under the GS1 EPC Tag Data Standard. Each is defined as a Calibrator, associated with the Gate as a sublocation, and persisted in the Database of Things.
6. The Controller enters Calibration Mode by commanding a Spatial Reader to scan RFID tags, identify only Calibrators, and for each Calibrator return a series of Tag Records containing x-y coordinates, timestamp, and N, the count of tag identifications since the prior Tag Report.
7. When SUM (Calibrator N) exceeds Confidence Factor, the Controller calculates a Vertex from the normalized average of the Calibrator x-y coordinate series.
8. When the Controller has calculated Vertices for all Gate Calibrators, it calculates an Ingress Line define by the two special Vertices “A>” and “B<”.
9. Upon completion of the Gate Ingress Line, the Controller persists it and the Vertices in the Database of Things, and the Gate becomes Calibrated. A Gate remains Calibrated until requested to recalibrate, so that Calibrators can be removed from the Gate area and secured out of the way to ensure that the Calibrators will not affect the capture of Item tags during operation.

FIG. 1 show a non-limiting example of a dashboard display illustrating the positions of the Calibrators, the Ingress Line, and a plurality of Items moving through a Gate area.

### The Capture Algorithm

1. Once the Gate is Calibrated, The Controller commands the Spatial Reader to begin identifying Item tags.
2. When an Item tag is first identified, the Controller calculates if it is approaching from the ingress side of the Line of Ingress and assigns it an Ingress status, otherwise assigning an Egress status.
3. As additional tag identifications occur, the Controller employs a Thresholding Algorithm that will be operative to calculate if each tag enters the Capture Zone, and the configuration of the polyhedral that is associated with each tag and which is described by the Vertices of the polyhedral for each tag. The Thresholding Algorithm may embody cartesian, pattern matching, artificial intelligence, and similar methods.
4. Tags never entering the Capture Zone become Loiterers or Drive-Bys and are ignored.
5. Tags exiting the Capture Zone together within the Grouping Interval are aggregated into a Movement Event, which is typed as Ingress or Egress according to the predominant tag state in the grouping.
6. The Movement Event is persisted to the Database of Things.

Turning now to FIG. 1, this figure presents an isometric view of a capture zone 100 consistent with certain embodiments of the present invention. In an embodiment, a phased-array RFID scanner 102 is positioned above a doorway 104 such that a capture zone 100 is defined that encompasses the entirety of the doorway 104. The capture zone 100 is further defined as that area around and including the doorway in which signals from multiple RFID tags 106 may be captured. In this embodiment, the RFID tags 106 may be passive or active, where passive tags respond to an activation signal from the RFID scanner 102 to emit an identifying signal for the passive tag, and active tags are emitting the identifying signal for the tag without requiring an activation signal.

Items are assigned RFID tags 106 in which the RFID tag identifier is coupled to an asset record in a database. When the RFID tag signal is captured by the RFID scanner 102, the scanner 102 is active to communicate with the Edge Capture platform to transmit the captured RFID tag identifier. The Edge Capture platform may then match the RFID tag to the asset identifier and update the asset record to place a timestamp and a doorway 104, or other access point, location to the Item. Thus, all Items having an RFID tag 106 associated with that asset may be tracked by time and location through a facility.

In the embodiment, multiple Items may be tagged and captured as they pass through the capture zone 100 of the Phased-array RFID scanner 102 that is located on a particular doorway 104 or access point. An issue with multiple RFID tag capture is that spurious data signals may sometimes be generated by objects or other tags located close enough to the capture zone to place a spurious signal in the data capture information produced by the Phased-array RFID scanner 102. The Edge Capture system is optimized to filter out signals that have been detected prior to the tracked assets passing through the capture zone and continue to be present after the tracked assets have left the capture zone. Signals that may be present due to being generated by other structures or objects in the facility are also filtered out of the captured data from the tracked assets. The Edge Capture system is thus capable of identifying, with high accuracy, those RFID tags 106 that are placed upon and associated with multiple assets moving, such as on a forklift 108 or other conveyance, through a doorway 104, accessway, or other defined capture zone and update records associated with those assets as to time and place of the location of those multiple Items.

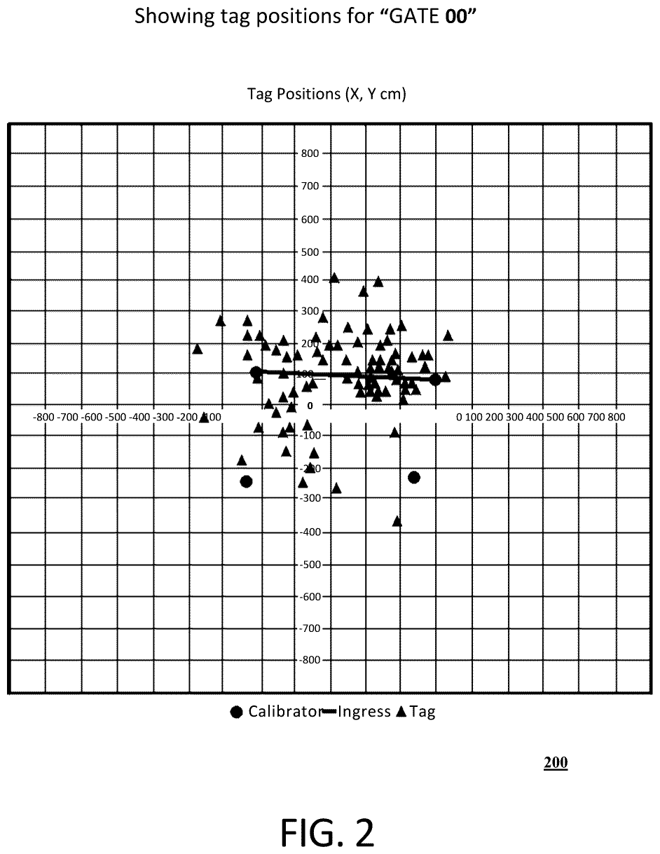

Turning now to FIG. 2, this figure presents a screen view of an exemplar dashboard display consistent with certain embodiments of the present invention. This diagram presents an image of data capture of multiple RFID tags as they move through an access point capture zone 200. The circles define calibration elements that serve to calibrate the operation and signal strength of the RFID signals as received by the Phased-array scanner. The horizontal line represents the physical position of the doorway or access way. The triangular data points represent each RFID tag as the tag detection and position was calculated by the Thresholding Algorithm. In this exemplary image, there can be seen some scatter as the signals from the RFID tags are identified and captured by the scanner. It can be seen that all RFID tags are identified and logged within 400 centimeters of the gateway, identified as GATE 00 in this example. All RFID tags are captured and categorized as passing through this gateway either prior to or after passing through the Ingress line, providing the ability to track all RFID tags through this accessway regardless of the number of assets and associated tags that move through.

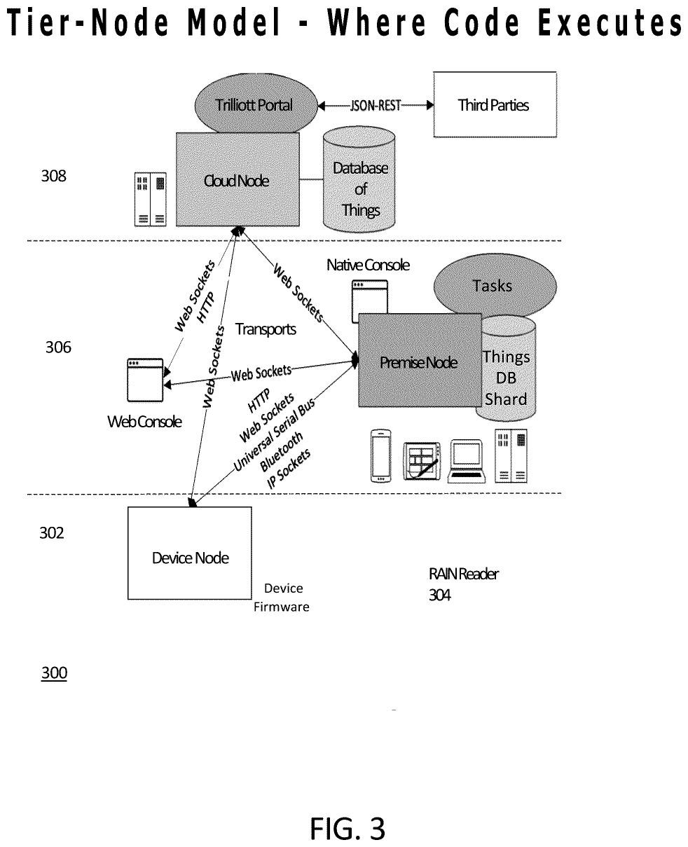

Turning now to FIG. 3, this figure presents an architectural view of the tier-node model utilized to execute application code consistent with certain embodiments of the present invention. This figure presents the architectural tier for code execution when the Edge Capture platform is active. Things are associated with RFID tags and are at the lowest tier providing simple identification and timestamp information at the Thing Tier 300. The device tier 302 executes command and control code for devices that gather data from the things that are tagged utilizing devices such as the RAINReader 304. The premise or edge tier 306 executes tasks that gather the data from the devices and format and transmit the information for storage and tracking by the system.

As shown in FIG. 3, the devices instantiated in the device tier 302, such as, in a non-limiting example, a RAINReader 304, may collect signals from RFID tags attached to or associated with Things in the Thing tier 300. The collected signal information is transferred to the Device node, which is in electronic communication with the Premise Node and the Cloud Node through a plurality of connection capabilities such as Web Sockets, HTTP connection, Bluetooth, IP Sockets, and even may provide a physical connection through a Universal Serial Bus (USB) connection. The Premise Node is responsible for configuring and running tasks for formatting and transmitting the information received from the Device node and storing and tracking the information in a Things database shard that is maintained on the Premise Node. The Cloud tier is the networked tier that collects the tracking information from the edge tier, stores that information into a data store, shown here as the “Database of Things”, formats the information for consumption by third party systems or local users, and provides this formatted data to users through the Trilliott Edge System portal.

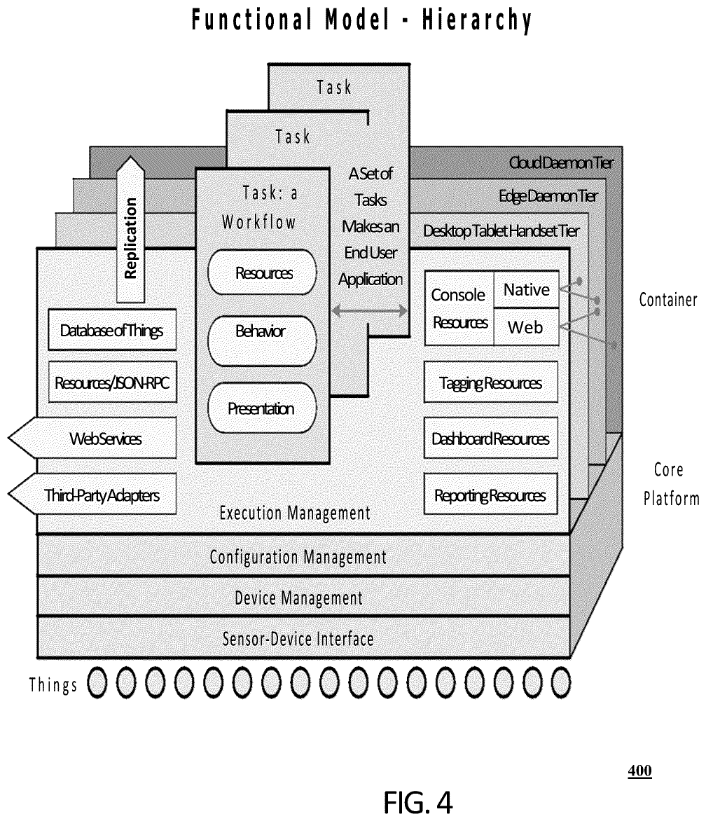

Turning now to FIG. 4, this figure presents a screen view of the functional hierarchy for execution of applications in the platform consistent with certain embodiments of the present invention. This figure presets a layered view for execution of portions of the Edge Capture platform 400. The layers of data collection and command and tracking execution are split between the core platform, which is responsible for all configuration, device, and sensor operation and management, and the Container, which provides for all data collection, cloud integration, data presentation, and data storage. The container layer is fully functional as a separate entity and may be installed on any computer, laptop, iPad, Tablet, smart phone, or other processing device, permitting the container to be portable and dynamically updated, changed, or ported as required by the user or implementation desired.

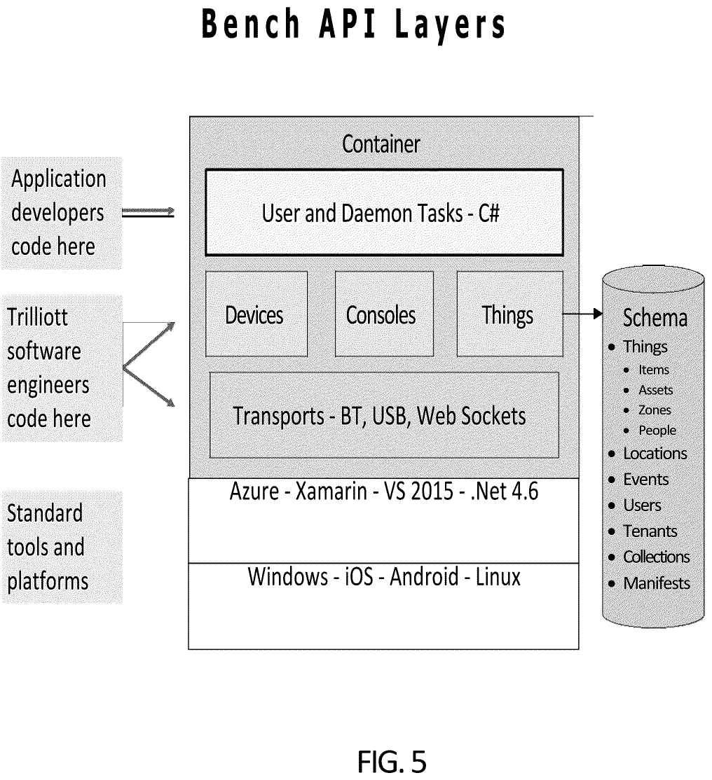

Turning now to FIG. 5, this figure presents an architectural view of the application code layers for access by developers consistent with certain embodiments of the present invention. In another embodiment, the Edge Capture system is implemented on an open architecture which provides the ability for third party application developers, or developers on staff at a client site, to create applications and tasks that are integrated into the portable container. The container also encompasses Edge Capture system applications that provide the Schema for Things, locations, events users, tenant, collections, manifests and other information that is required to manage and control the Edge Capture system. The Edge Capture system applications also manage devices, information loading of consoles for user interface, transportation of data between application and components of the system and other back-office features of the Edge Capture system. The container may be built on a platform that takes advantage of standard tools and application layers to permit and support installation and transportability of the Edge Capture system from one hardware platform to another.

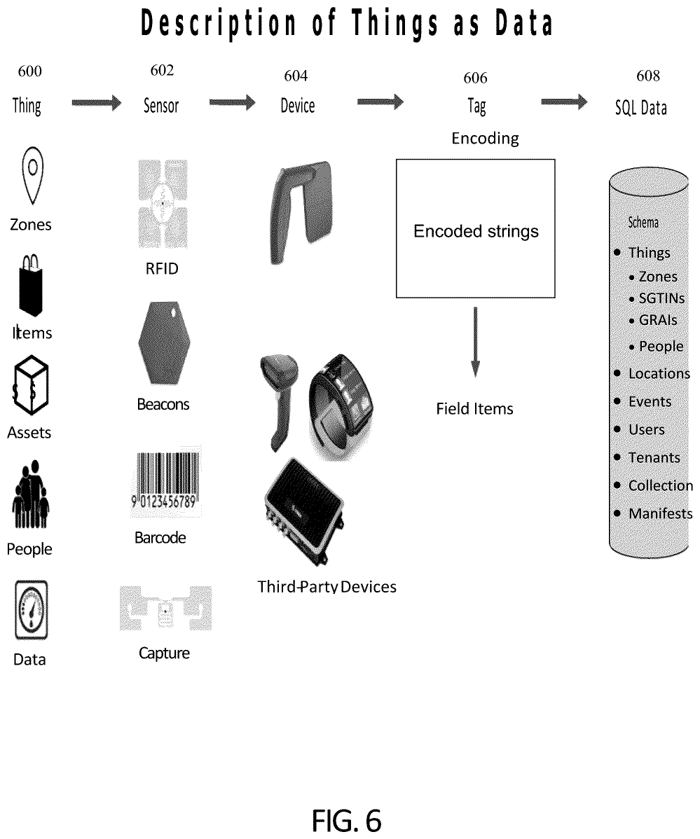

Turning now to FIG. 6, this figure presents a description of how data elements are represented in the application platform consistent with certain embodiments of the present invention. Devices and other objects may be represented as data elements, or “things”, that the system recognizes and has the ability to manage and track through operation of the Edge Capture system. This diagram presents a non-exhaustive list of things that are data elements to be stored and tracked by the system.

In an embodiment, “things” may be described as any item, position, area, or person onto which an RFID tag, either active or passive, may be affixed. A non-limiting list of some items that may be classed as “things” is presented at 600. This list may include physical zones, materials or material items, assets and products, individual persons, and data values. At 602 a non-limiting list of RFID tags and other sensors that may be assigned or affixed to a thing, such as active or passive RFID tags, Bluetooth or other emitting beacons, Barcodes assigned and affixed, and/or capture sensors. At 604, the system may be connected to one or more devices that are active to collected data from any of the sensors that may be affixed to or associated with a “thing”. These may include the previously mentioned RAINReader or other third-party devices for capturing the information from a sensor or tag. At 606, the tags or sensors will provide an encoded string that will represent the field items for which data has been collected and will be encoded for later processing, storage, and tracking by the system. At 608, the figure provides a non-limiting list of the SQL data that is created from the encoded strings for each captured data string, where the SQL data has been processed to be inserted into a schema and stored into an electronic storage medium that is part of the system server. This non-limiting schema may provide for the storage of SQL Data 608 associated with Things, including zones, items, assets, people, and other data, locations, Events, Users, Tenants, Data Collection, and Data Manifests.

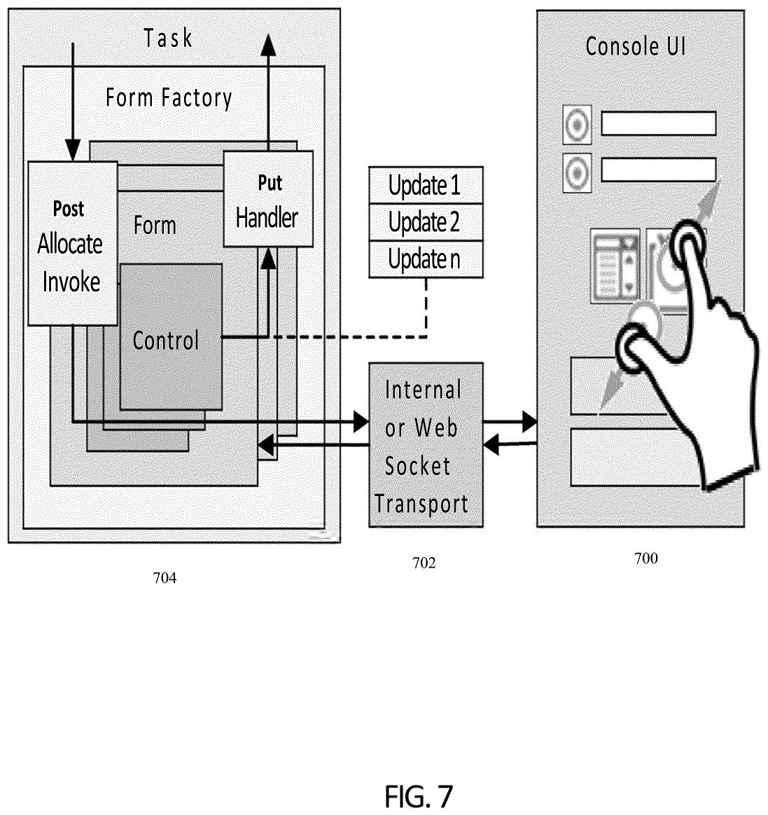

Turning now to FIG. 7, this figure presents an operational view of the use of controls in the platform consistent with certain embodiments of the present invention. In an embodiment, in operation the Edge Capture system may provide a user with one or more console User Interfaces (UIs) 700 to permit the user to interact with and control the data capture functions of the system. In an embodiment, the user may be provided with one or more sliders on a UI panel to initiate functions and features of the Edge Capture system. Upon initiation through contact with a slider, the console UI will transmit a signal through Internal or Web Socket transport functions 702 to initiate or control a function. Edge Capture system may then invoke the task 704, put a call for data capture, collect incoming captured data, formulate the information into one or more records and store this information into the cloud-based data store. The information may also be formatted for presentation and use by the user.

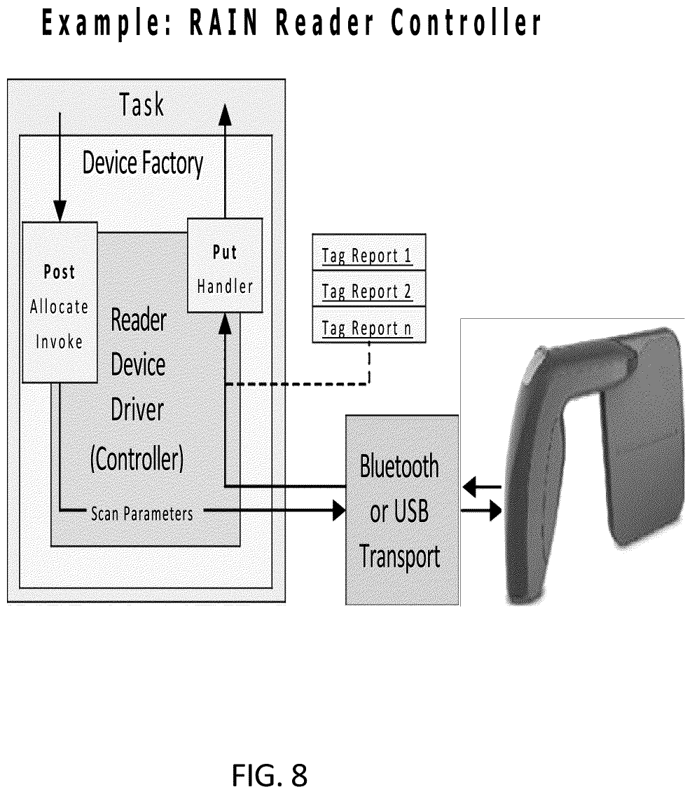

Turning now to FIG. 8, this figure presents an operational example of a device in use with the platform consistent with certain embodiments of the present invention. In a non-limiting example, this figure presents operational control, as discussed in FIG. 7, by a user where the input device is a RAIN RFID reader controller.

While certain illustrative embodiments have been described, it is evident that many alternatives, modifications, permutations and variations will become apparent to those skilled in the art in light of the foregoing description.

We claim:

1. A system for edge capture of data signals comprising:
a data processor enabled to communicate with a data capture device;
said data capture device collecting discrete, raw sensor input from a plurality of things having sensors or tags associated with each of said things detected within a capture zone;
said data processor collecting all discrete, raw sensor input from each of said sensors or tags and performing a thresholding algorithm calculation to determine ingress status or egress status of said sensor or tag;
said data processor determining if an ingress status and/or egress status sensor input has been detected for each of said sensors or tags;
said data processor collecting all sensor or tag signals for a grouping interval, decoding id information and timestamp information for each sensor or tag signal, and storing said id and timestamp information into a database schema;
said data processor providing user access to said database schema to track and monitor said sensors and/or tags through one or more capture zone locations.

2. The system of claim 1 where said capture zone is defined as a virtual convex polyhedron space within which sensor or tag data collection is performed.

3. The system of claim 1, where said captured sensor or tag information is displayed in a graphic view of sensor or tag position in said capture zone.

4. The system of claim 1, where said data processor assigs a movement event for each ingress status and egress status detected for each sensor or tag in said capture zone within a defined grouping interval.

5. The system of claim 1, further comprising a Transaction System process that ingests events from sensor or tag input, persists said events in a local database, and communicates with said edge collection system or with external legacy systems, to forward events according to pre-configured requests.

6. The system of claim 1, further comprising one or more tasks that gather collection device data and format and transmit said data to the edge capture system for storage and tracking of said devices.

7. The system of claim 1, further comprising a container to provide the schema for things, locations, events, users, tenants, collections, manifests, and other information that is required to manage and control said edge capture system.

8. The system of claim 1, where the edge capture system further comprises one or more console or mobile user interfaces to facilitate user interaction with the edge capture system.

9. The system of claim 8, further comprising formulating captured sensor and tag information into one or records for presentation to and interaction by the user.

10. The system of claim 1, where said edge capture system extracts discrete events comprising movements, counts, groupings, triggers, and singulations and stores said events for later processing.
